(19) United States
(12) Patent Application Publication
(10) Pub. No.: US 2025/0024796 A1
(43) Pub. Date: Jan. 23, 2025

(54) WATERING SYSTEM FOR TREES

(71) Applicant: Wilhelm DYCK, Augsburg (DE)

(72) Inventor: Wilhelm DYCK, Augsburg (DE)

(21) Appl. No.: 18/714,874

(22) PCT Filed: Dec. 2, 2022
(86) PCT No.: PCT/EP2022/084249

§ 371 Date: May 30, 2024

(30) Foreign Application Priority Data
Dec. 2, 2021 (GB) 2117463.6

(51) Int. Cl. A01G 27/00; A47G 33/12

(52) U.S. Cl. CPC A01G 27/008; A47G 33/12; A47G 2033/1286

(57) ABSTRACT

A watering system for Christmas trees is disclosed having a humidifier for generating mist and a conduit for dispensing at least a part of the mist generated by the humidifier towards foliage of the tree, when in use.

### BACKGROUND OF THE INVENTION

The present disclosure relates to a watering system, particularly but not exclusively, for trees, more particularly for Christmas trees. Another aspect of the present disclosure relates to a conduit for a watering system. Yet another aspect of the present disclosure relates to the use of a humidifier for watering trees, particularly but not exclusively Christmas trees.

Every year, thousands of evergreen conifer trees make their way into the living rooms of people's homes in preparation for Christmas. Originally a German tradition among the upper class, associated with Saint Boniface, Christmas trees have become a Christmas staple worldwide. These evergreen conifers, such as fir, spruce or pine are decorated with an ever increasing variety of accessories such as lights, whether they are candles or electric lights, Christmas tree balls, tinsel, candy, stars and many more. The demand for Christmas trees has become so high that prices for the evergreens have risen sharply over the years. Indeed, large Christmas trees together with exclusive decorations have become a status symbol in many societies.

Of course, being able to put up Christmas trees indoors requires them to be felled, packaged, shipped and sold ready for the festive season. Often, the trees sold in supermarkets or home depots are felled days, if not weeks, before they are picked up by their new owners. Every day the evergreen is detached from its roots, the colour and density of its foliage deteriorates, resulting in a very limited lifetime for Christmas trees during the festive season. As a consequence, most people will buy and decorate their trees only very shortly before Christmas to keep the tree looking healthy and strong for the holidays. Even commonly used Christmas tree stands, which are provided with a water reservoir that the stem can sit in only extend the life of the beloved Christmas ornaments for a short period of time.

The ever increasing cost is not the only issue. Due to the limited lifetime of Christmas tree, many Christmas enthusiasts have started to opt for alternatives, such as artificial Christmas trees. After all, searching for and buying Christmas trees, transporting them home, setting them up, decorating the evergreens and finally clearing them away, after merely a few weeks (or even days) of use, represents a significant effort many are no longer willing to make. Yet, there remains a large demand for real Christmas trees due to their unmistakable smell and feeling of warmth.

It is an aim of the present disclosure to solve or at least ameliorate one or more problems of the prior art. In particular, it is an object of the present disclosure to provide ways of extending the lifetime of felled trees, such as evergreens during Christmas.

### SUMMARY OF THE INVENTION

Aspects and embodiments of the present disclosure provide a watering system, particularly but not exclusively, for trees, more particularly Christmas trees, as claimed in the appended claims. Another aspect of the present disclosure relates to a conduit for a watering system. Yet another aspect of the present disclosure relates to the use of a humidifier for watering trees, particularly but not exclusively Christmas trees.

According to a first aspect of the present disclosure, there is provided a watering system for Christmas trees comprising a humidifier for generating mist and a conduit for dispensing at least a part of the mist generated by the humidifier towards foliage of the tree, when in use.

In an embodiment, the conduit comprises at least one opening for dispensing the mist.

According to another embodiment, the at least one opening of the conduit extends substantially perpendicularly with respect to a longitudinal axis of the conduit.

According to another embodiment, the at least one opening of the conduit has a diameter that is smaller than an inner diameter of the conduit.

According to another embodiment, the conduit comprises at least one side wall, and wherein the at least one opening extends through said side wall.

According to another embodiment, the conduit comprises at least one side wall, and wherein the side wall is at least partially permeable to mist generated by the humidifier.

According to another embodiment, the conduit comprises a plurality of openings.

According to another embodiment, each of the openings extends through a side wall of the conduit.

According to another embodiment, the conduit comprises a first end connected or connectable to the humidifier and an opposite, second end, and wherein the openings arranged closer to the second end of the conduit have a diameter that is larger than a diameter of openings arranged closer to the first end of the conduit.

According to another embodiment, the conduit comprises a first end connected or connectable to the humidifier and an opposite, second end, and wherein an inner diameter of the conduit at its first end is larger than an inner diameter of the conduit at its second end.

According to another embodiment, the conduit is configured to be attached to the tree such that, when in use, the conduit is arranged to dispense the mist away from a stem of the Christmas tree and towards its foliage.

According to another embodiment, the conduit is configured to be attached to the Christmas tree at least along its second end.

According to another embodiment, the conduit comprises at least one fastening mechanism for removably connecting parts of the conduit to a stem of a tree. According to another embodiment, the at least one fastening mechanism comprises a collar, wherein the collar is configured to be removably arranged around a stem of the tree, the collar comprising a mist inlet connectable to a second end of the conduit and at least one mist outlet.

According to another embodiment, the collar comprises a first mist outlet configured to connect to a first end of a second conduit.

According to another embodiment, the collar comprises a second mist outlet arranged to face foliage of the tree, when the collar is in use, the second mist outlet preferably being configured as a mist outlet nozzle.

According to another embodiment, the conduit is made of cardboard, polyurethane, vinyl, rubber, or polymer.

According to another embodiment, the humidifier is a warm mist humidifier or an ultrasonic humidifier.

According to another embodiment, the humidifier comprises a water feed hose adapted to draw water from a Christmas tree stand.

According to another embodiment, the humidifier comprises a refillable water tank, said refillable water tank preferably being removable from the humidifier.

According to another embodiment, the system comprises a return basin configured to collect water droplets falling from the leaves of the tree. The return basin may be a tray arranged below the Christmas tree. In some examples, the basin may be a funnel member that is removably attachable to a tree stand of the Christmas tree.

According to another embodiment, the system comprises a humidity sensor adapted for generating air-humidity-data representative of an air humidity surrounding the tree.

According to another embodiment, the system comprises a control unit configured to:
receive air-humidity-data representative of an air humidity surrounding the tree;
determine a mist-flow-signal on the basis of the humidity data;
adjust a flow of water mist provided by the humidifier on the basis of the mist-flow-signal.

According to another aspect of the present disclosure, there is provided a conduit comprising a first end connectable to a humidifier and a second end attachable to a Christmas tree, wherein the conduit is configured to dispense at least a part of the mist generated by a humidifier towards foliage of the tree, when in use.

According to another aspect of the present disclosure, there is provided method of using a humidifier for watering trees, preferably fir trees.

In one embodiment, the method comprises directing mist generated by the humidifier towards the foliage of the tree.

In another embodiment, the method comprises directing the mist towards the foliage of the tree from inside the tree.

Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible.

The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The aforementioned and other features and advantages of this disclosure, and the manner of attaining them, will become more apparent and the disclosure will be better understood by reference to the following description of embodiments of the disclosure taken in conjunction with the accompanying drawings, wherein:

FIG. 1 shows a schematic diagram of an embodiment of a watering system according to the present disclosure;

FIG. 2 shows a schematic diagram of an embodiment of a watering system according to the present disclosure;

FIGS. 3 to 6 show schematic diagrams of embodiments of a watering conduit according to the present disclosure;

FIG. 7 shows a schematic diagram of a junction element;

FIG. 8 shows a schematic diagram of a collar; and

FIG. 9 shows a schematic diagram of an embodiment of the watering system according to an embodiment of the present disclosure using the collars of FIG. 8.

Corresponding reference characters indicate corresponding parts throughout the several views. The exemplifications set out herein illustrate embodiments of the disclosure, and such exemplifications are not to be construed as limiting the scope of the disclosure in any manner.

### DETAILED DESCRIPTION

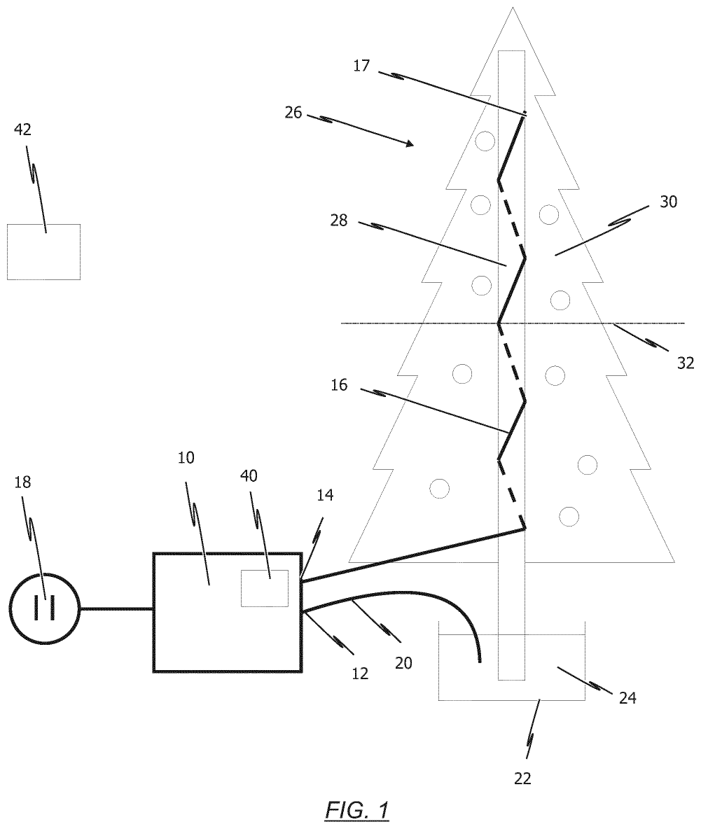

FIG. 1 shows a schematic illustration of an embodiment of the watering system of the present disclosure. The watering system comprises a humidifier 10. The humidifier 10 is configured to generate mist. In some examples the humidifier 10 is a cool mist humidifier, such as an ultrasonic humidifier that uses ultrasonic frequencies to generate mist or cold fog made of fine water droplets. In some embodiments, the humidifier 10 may comprise a fan for pushing the cold fog out of a housing of the humidifier, e.g. via a mist outlet 14.

In the embodiment of FIG. 1, the humidifier 10 comprises a water inlet 12. The water inlet 12 is connected to a water supply 24, in this example a Christmas tree stand 22 with an integrated water reservoir, via an inlet line 20. Alternatively, the water inlet 12 may be connected to a dedicated water reservoir, e.g. a bucket of water that is separate from the Christmas tree stand 22. The humidifier 10 of FIG. 1 may comprise a pump for drawing water from the Christmas tree stand 24.

The humidifier 10 comprises a mist outlet 14. The mist outlet 14 is connected to a conduit 16.

The conduit 16 has a first end that is connectable and removable from the mist outlet 14 of the humidifier 10. The conduit 16 of FIG. 1 is attached to a stem 28 of a Christmas tree 26. The conduit 16 may be temporarily attached to the Christmas tree 26, e.g. via clips or straps.

The conduit 16 may be made of a flexible material to allow for the conduit to be wrapped around the stem 28 of the Christmas tree, as is shown in FIG. 1. The conduit 16 in FIG. 1 may be an elastic pipe. The conduit 16 is configured to dispense mist generated by the humidifier 10 along an upper half of the Christmas tree, indicated by line 32. Mist dispersed above line 32 will be absorbed by the tree via foliage 30. Mist dispersed by the conduit 16 in the upper half of the tree 26 will fall, thereby covering the foliage 30 of the tree 26.

In some embodiments, the second end 17 of the conduit 16 is configured to be attached along the top of the stem 26 of tree 28. The conduit may include clips or straps attached to the second end 17 for fastening the conduit 16 to the stem 26.

The humidifier 10 comprises a mains power plug 18 for powering dispersing the water into mist. Alternatively, or additionally, the humidifier may comprise a battery, capacitor, or any other type of electrical power storage. In some embodiments, the humidifier may include a battery researchable via the mains power plug 18. The humidifier 10 may be configured to recharge its battery when running of a mains power supply. In some examples, the mains power plug 18 may be replaced by a USB charging cable or similar power interfaces.

The watering system of FIG. 1 further comprises a control unit 40, configured to control the production and thus the flow of mist provided by the humidifier 10. The control 40 of FIG. 1 is part of the humidifier 10. However, it is also feasibly to arrange the control unit 40 remotely from the humidifier 10, in which case the control unit may communicate with the humidifier 10 wirelessly.

The watering system of the embodiment in FIG. 1 comprises a humidity sensor 42. The humidity sensor may be arranged anywhere within the room, yet preferably between 1 m and 3 m away from the second end 17 of the conduit. The humidity sensor 42 is connected to the control unit 40, e.g. wirelessly, to enable data-transfer between the humidity sensor 42 and the control unit 40. The humidity sensor may transfer air humidity measurements intermittently or continuously to the control unit 40 in the form of air-humidity-data. The control unit 40 may control an amount/flow of mist provided by the humidifier 10 on the basis of the air-humidity-data. In some embodiments, the control unit 40 may be configured to compare air humidity measurements provided by the sensor 42 via the air-humidity-data to an upper-humidity-threshold. If the air-humidity-data is indicative of a humidity level within the room that exceeds the humidity-threshold, the control unit 40 may reduce or (temporarily) pause the production of mist via the humidifier. The control unit 40 may be configured to reduce or pause the mist production until the air-humidity-data is indicative of the humidity having dropped below the upper-humidity threshold once again.

The control unit 40 may be configured to increase the production of mist via the humidifier if the air-humidity-data is indicative of the humidity level within the air surrounding the tree 26 having dropped below lower-humidity-threshold.

In this way, the control unit 40 will ensure sufficiently high levels of humidity for the foliage of the tree to stay fresh, and, at the same time, avoids excessive amounts of humidity, which could result in mould forming inside a user's home.

The control unit may control the humidifier by generating a mist-flow-signal on the basis of the air-humidity-data. The control unit 40 may be configured to provide the mist-flow-signal to a circuit board of the humidifier 10 to adjust the mist production levels, according to the above algorithm.

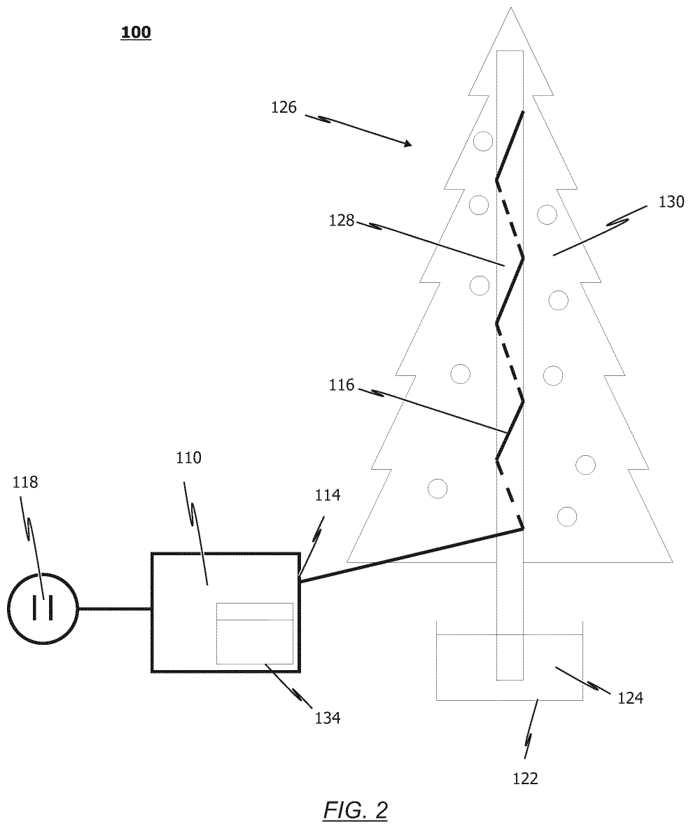

Turning to FIG. 2, there is shown another embodiment of a watering system according to the present disclosure. The watering system 100 of FIG. 2 also comprises a humidifier 110 with a mist outlet 114 and a mains power plug 118. The mist outlet 114 is connected to a first end of a conduit 116.

The conduit 116 is configured for transferring mist provided by the humidifier 110 via the mist outlet 114 to a Christmas tree 126. To this end, the conduit 16 may be wrapped around and/or removably attached to a stem 128 of the tree 126.

The conduit 116 is configured and attached to the stem 128 in such a way that mist dispersed by the conduit 116 will be directed towards the leafs/foliage 130 of the tree 126. The leafs/foliage 130 of the tree will quickly absorb the moisture provided by the mist, resulting in healthier foliage 130 for longer periods of time.

The Christmas tree 126 of FIG. 2 is received in a stand 122 that may include a reservoir for a body of water accessibly by the stem 128.

In contrast to the embodiment of FIG. 1, the humidifier 110 of FIG. 2 comprises an integrated water tank 134 that is removably received within a housing of the humidifier 134. The water tank 134 may be sized to allow for the humidifier 10 to produce mist for watering the tree 126 for a predetermine amount of time, e.g. a day, before needing to be refilled by the user. As will be understood, the watering system 100 of the second embodiment does not require a water inlet line (c.f. 20, FIG. 1) and is thus freely movable together with the water tank 134.

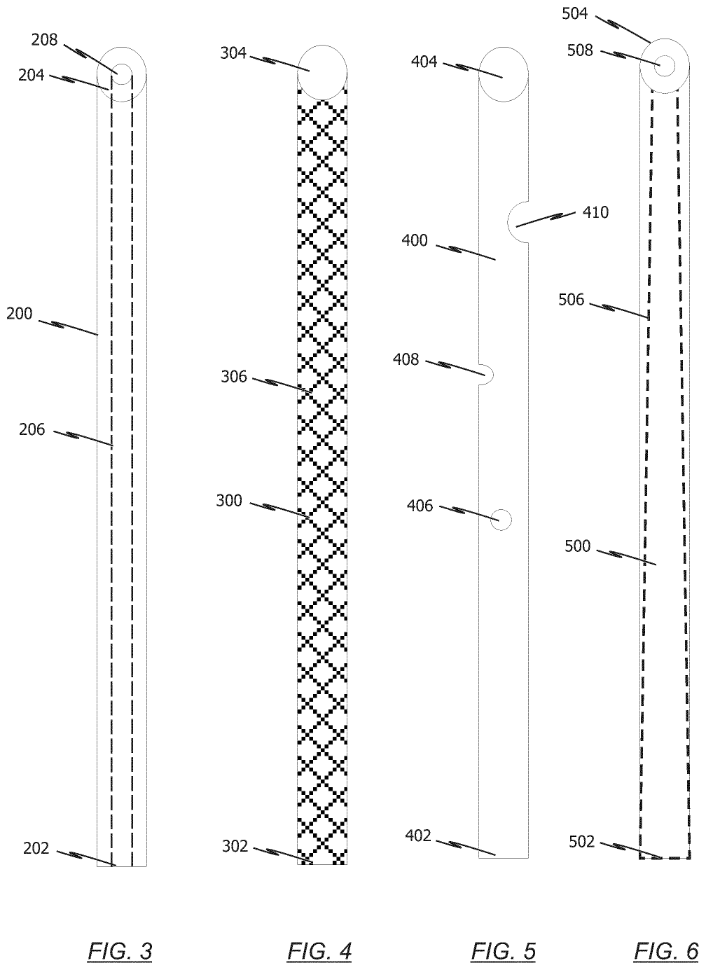

Turning to FIGS. 3 to 6, there are shown various embodiments of a conduit for a watering system according to the present disclosure. The conduits are configured to dispense at least a part of the mist generated by a humidifier along an upper half of the Christmas tree, when in use.

FIG. 3 shows a first conduit 200 with a first end 202 for connecting the conduit 200 to an outlet of a corresponding humidifier. The conduit 200 has a second end 204 arranged opposite the first end 202 and configured to dispense mist provided by the humidifier (not shown). To this end, the conduit 200 comprises an inner channel 206 extending between the first end 202 and the second 204. At the second end 204, the conduit 200 comprises an opening 208. The opening 208 is an outlet opening for mist extending form the first end 202 through the channel 206. The channel 206 of the conduit 200 shown in FIG. 3 has a substantially constant diameter.

FIG. 4 shows another conduit 300 with a first end 302 for connecting the conduit 300 to an outlet of a corresponding humidifier. The conduit 300 has a second end 304 arranged opposite the first end 302. The conduit may be permeable to mist generated by a humidifier, either along its entire length (as shown in FIG. 4) or only partly along its length. In one example, 50% or less of the conduit 300 may be permeable. In particular, up to 50% of the conduit, e.g. the 50% extending form the second end 304 towards the first end 302 may be permeable, whereas the first 50% (or more) of the conduit extending from the first end 302 may be impermeable. In this example, mist may be dispensed toward the foliage of the Christmas via the permeable parts of the conduit 300. In some examples, the conduit 300 may be configured such that the permeable parts of the conduit 300 may be attached to an upper half of the Christmas tree, whereas impermeable parts are sized to allow for a connection of the permeable parts with a corresponding humidifier.

FIG. 5 shows another conduit 400 with a first end 402 for connecting the conduit 400 to an outlet of a corresponding humidifier. The conduit 400 has a second end 404 arranged opposite the first end 402. The conduit 400 comprises a plurality of openings 406, 408, 410 extending through a side wall of the conduit 400, i.e. between an inner channel (similar to channel 206 shown in FIG. 2) and an outer surface of the conduit 400. In the example of FIG. 5, the openings 406, 408, 410 are distributed around the circumference of the conduit 400. In some embodiments, however, the openings may be arranged longitudinally in a row.

FIG. 5 shows three openings 406, 408, 410. Of course, the conduit may comprise any number of openings extending through the side walls of the conduit. The openings 406, 408, 410 of the conduit 400 shown in FIG. 5 comprise varying sizes. In the embodiment of FIG. 5, the openings closer to the second end 404 are larger in size than openings closer to the first end 402. In other words, the plurality of openings increase in size towards the second 404. The increase in opening size will provide a more homogenous dispense of mist from the openings of the conduit 400.

FIG. 6 shows another conduit 500 with a first end 502 for connecting the conduit 500 to an outlet of a corresponding humidifier. The conduit 500 has a second end 504 arranged opposite the first end 502 and configured to dispense mist provided by the humidifier (not shown). To this end, the conduit 500 comprises an inner channel 506 extending between the first end 502 and the second 504. At the second end 504, the conduit 500 comprises an opening 508. The opening 508 is an outlet opening for mist extending from the first end 502 through the channel 506. The channel 506 of the conduit 500 shown in FIG. 6 has a decreasing diameter. In particular, the diameter of the inner channel 506 of conduit 500 decreases in size from the first end 502 towards the second end 504.

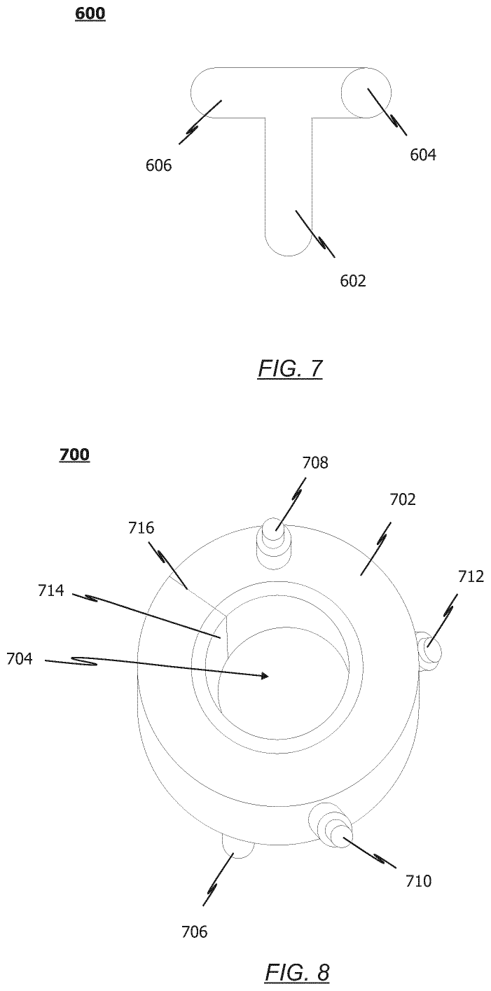

Turning to FIG. 7, there is shown a junction element 600. The junction element 600 comprises a mist inlet 604. The mist inlet 604 is configured to attach to a second end of the conduit (e.g. conduit 200 in FIG. 3). The junction element 600 comprises a first mist outlet 606 configured to attach to a first end of a second conduit (e.g. another conduit 200).

The junction element 600 comprises a second mist outlet 602. The second mist outlet 602 is configured to dispense at least parts of the mist introduced into the junction element 600 via the mist inlet 604 towards foliage of the tree (not shown). Accordingly, the second mist outlet may be a mist nozzle. The second mist outlet 602 of FIG. 7 extends in a substantially perpendicular direction to the mist inlet 604 so as to direct mist introduced into the junction element 600 away from the stem of the tree, if the mist inlet 604 is tied to said stem. In some examples, the mist inlet 604 and/or the first mist outlet 606 of the junction element 600 may be used to tie the junction element 600 against the stem of the tree, e.g. by means of cable ties.

The junction element 600 of FIG. 7 is a T-piece, although any other shape, such as a Y-shape, are feasible as long as the junction element comprises at least one mist inlet and at least two mist outlets.

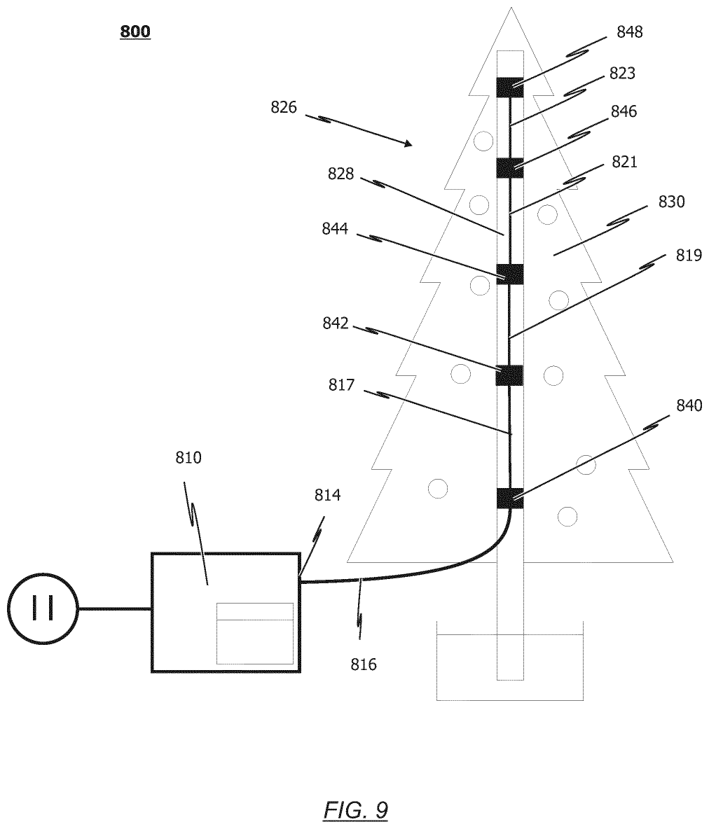

Another type of junction element is shown in FIG. 8. The junction element shown in FIG. 8 is a collar 700 configured to act as a fastening mechanism for removably attaching the conduit to the Christmas tree, as will be explained in more detail with respect to FIG. 9 below.

The collar comprises a hollow body 702 and a mist inlet 706 connected to the hollow main body. The hollow body defines a mist chamber. The mist inlet 706 is configured to attach to a second end of the conduit (e.g. conduit 200 in FIG. 3). The collar 700 comprises a first mist outlet 708 configured to attach to a first end of a second conduit (e.g. another conduit 200). The mist inlet 706 is arranged on a first surface of the collar, whereas the first mist outlet is arranged on a second surface that is opposite to the first surface. In use, the first surface will be facing towards a bottom end of the tree, whereas the second surface will be facing towards a top end of the tree.

The collar 700 comprises a central opening 704. The central opening 704 is sized to receive the stem of a tree. The mist inlet 706 and the first mist outlet 708 may be arranged on diametrically opposite sides of the opening 704 of the collar to allow the first and second conduits to be installed on substantially opposite sides of the stem. This may simplify installation of the conduits. Moreover, arranging the mist inlet 706 and the first mist outlet 708 on diametrically opposite sides of the opening will force mist introduced into the hollow body 702 of the collar 700 to travel around the entire mist chamber to reach the first mist outlet 708.

As will be appreciated, the stem size of different Christmas trees may vary to some extent. Accordingly, the collar comprises a gasket 714 surrounding the circumference of the opening 704. The gasket 714 is configured to conform to the shape of the Christmas tree stem, when the collar 700 is attached to the tree.

The collar 700 comprises an opening portion 716. The opening portion 716 may be a normally biased closed. In one example, this may be implemented by constructing the hollow body 702 and the gasket 714 of elastic material that allow the opening portion 716 to be widened to slip the collar of the stem of a tree. In other embodiments (not shown) the collar 700 may comprise a hinge, e.g. diametrically opposite to the opening portion 716, that allows the collar to be pivoted about the hinge to open or close the opening portion 716, when installing the collar 700. In this embodiment, the hinge may either be biased into to closed position (e.g. via a coil spring) or the collar 700 may comprise a latch at the opening portion 716 to fix the collar shut when the collar 700 is attached to the stem, i.e. when the gasket 714 has conformed to the outer surface of the stem.

The collar 700 comprises a second and third mist outlet 710, 712. The second and third mist outlets 710, 712 are configured to dispense at least parts of the mist introduced into the collar 700 via the mist inlet 706 towards foliage of the tree (not shown). Accordingly, the second and third mist outlets 710, 712 may be mist nozzles. The second and third mist outlets 710, 712 of FIG. 8 are connected to the hollow chamber of the hollow body 702 extend in a substantially perpendicular direction to the mist inlet 706. Parts of the mist introduced into the hollow body 702 will thus be re-directed by the second and third mist outlets 710, 712, away from the stem of the tree. Mist that is not dispensed by the second and third mist outlets 710, 712 will be introduced into a second conduit via the first mist outlet 708.

FIG. 9 shows an embodiment of the watering system using a plurality of the collars described above. The watering system of FIG. 9 comprises a humidifier 810 with a mist outlet 814. A first conduit 816 has a first end connected to the mist outlet 814 of the humidifier 810.

The watering system 800 of FIG. 9 comprises a plurality of collars 840, 842, 844, 846, 848 removable attached to the stem 828 of the tree 826. Each of the collars 840, 842, 844, 846, 848 comprises a one or more nozzles for dispensing mist introduced into the collars towards foliage 830 of the tree 826.

The first conduit 816 has a second end connected to a mist inlet of a first collar 840. A second conduit 817 extends between a first mist outlet of the first collar 840 and a mist inlet of a second collar 842. A third conduit 819 extends between a first mist outlet of the second collar 842 and a mist inlet of a third collar 844. A fourth conduit 821 extends between a first mist outlet of the third collar 844 and a mist inlet of a fourth collar 846. A fifth conduit 823 extends between a first mist outlet of the fourth collar 846 and a mist inlet of a fifth collar 848. The fifth collar 848 may not be provided with an outlet for connecting the fifth collar to another conduit. Alternatively, the fifth collar 848 may comprise a first outlet like the first to fourth collars 840, 842, 844, 846, whereas the first outlet is capped off to avoid mist being dispersed above the tree, rather than towards the foliage 830 via the nozzles of the fifth collar 848.

Of course the invention is not restricted to the number of collars implemented. Rather, any number of collars may be arranged around the stem 828 of the tree 826. Typically, the larger the tree, the more collars should be used to ensure an even distribution of mist.

The invention is not restricted to the embodiments described in connection with the drawings. Rather, the disclosure also includes combinations of the features shown therein. For example, it will be appreciated that each of the conduits will include an inner channel. Some conduits may comprise a combination of openings and permeable side walls.

1. A watering system for Christmas trees comprising
a humidifier for generating mist;
a conduit for dispensing at least a part of the mist generated by the humidifier towards foliage of the tree, when in use.

2. The watering system of claim 1, wherein the conduit comprises at least one opening for dispensing the mist.

3. The watering system of claim 2, wherein the at least one opening of the conduit extends substantially perpendicularly with respect to a longitudinal axis of the conduit.

4. The watering system of claim 2, wherein the at least one opening of the conduit has a diameter that is smaller than an inner diameter of the conduit.

5. The watering system of claim 2, wherein the conduit comprises at least one side wall, and wherein the at least one opening extends through said side wall.

6. The watering system of claim 1, wherein the conduit comprises at least one side wall, and wherein the side wall is at least partially permeable to mist generated by the humidifier.

7. The watering system of claim 1, wherein the conduit comprises a plurality of openings, wherein each of the openings extends through a side wall of the conduit.

8. (canceled)

9. The watering system of claim 7, wherein the conduit comprises a first end connected or connectable to the humidifier and an opposite, second end, and wherein the openings arranged closer to the second end of the conduit have a diameter that is larger than a diameter of openings arranged closer to the first end of the conduit.

10. The watering system of claim 1, wherein the conduit comprises a first end connected or connectable to the humidifier and an opposite, second end, and wherein an inner diameter of the conduit at its first end is larger than an inner diameter of the conduit at its second end.

11. The watering system of claim 1, wherein the conduit is configured to be attached to the Christmas tree such that, when in use, the conduit is arranged to dispense the mist away from a stem of the Christmas tree and towards its leaves.

12. The watering system of claim 11, wherein the conduit is configured to be attached to the Christmas tree at least along its second end.

13. The watering system of claim 1, wherein the conduit comprises at least one fastening mechanism for removably connecting parts of the conduit to a stem of a Christmas tree.

14. The watering system of claim 13, wherein the at least one fastening mechanism comprises a fastening clip or a fastening strap.

15. (canceled)

16. (canceled)

17. The watering system of claim 1, wherein the conduit is made of cardboard, polyurethane, vinyl, rubber, or polymer.

18. The watering system of claim 1, wherein the humidifier is a warm mist humidifier or an ultrasonic humidifier.

19. The watering system of claim 1, wherein the humidifier comprises a water feed hose adapted to draw water from a Christmas tree stand.

20. The watering system of claim 1, wherein the humidifier comprises a refillable water tank.

21. (canceled)

22. (canceled)

23. The watering system of claim 1, comprising a humidity sensor adapted for generating air-humidity-data representative of an air humidity surrounding the Christmas tree and wherein the watering system comprises a control unit configured to:
receive air-humidity-data representative of an air humidity surrounding the tree;
determine a mist-flow-signal on the basis of the humidity data;
adjust a flow of water mist provided by the humidifier on the basis of the mist-flow-signal.

24. A conduit for a watering system for Christmas trees, the conduit comprising a first end connectable to a humidifier and a second end attachable to a Christmas tree, wherein the conduit is configured to dispense at least a part of the mist generated by a humidifier along an upper half of the Christmas tree, when in use.

25. (canceled)

26. A method of watering a tree, comprising a) providing a watering system of claim 1; b) providing the humidifier of said watering system with water; c) attaching the conduit of the watering system to the stem of a tree whereby when the humidifier is activated, the conduit dispenses mist generated by the humidifier on the foliage of the tree.
